(19) United States
(12) Patent Application Publication
(10) Pub. No.: US 2005/0078217 A1
(43) Pub. Date: Apr. 14, 2005

(54) Method and system for clearing a teletext cache of a display device

(76) Inventors: Charles R. Hardt, Lawrenceville, GA (US); Cesar Moreno, Lawrenceville, GA (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 10/683,524

(22) Filed: Oct. 10, 2003

(51) Int. Cl. H04N 7/16; H04N 7/08; H04N 11/00; H04N 7/00; H04N 7/04

(52) U.S. Cl. 348/468; 348/469; 725/137; 725/136; 348/460

(57) ABSTRACT

A method for clearing teletext data includes transmitting the teletext to a display device, tracking the transmitted teletext data, generating a representation of the transmitted teletext data, accessing the representation upon a channel change, and instructing the display device to clear the transmitted teletext data according to the accessed representation of the transmitted teletext data.

### FIELD

The present method and system relate to clearing teletext data from a display device. More particularly, the present method and system relate to clearing cached teletext data by transmitting erase commands to a display device.

### BACKGROUND

A typical television receives an analog input signal that includes, among other things, textual data referred to teletext data. Teletext data is often used by the television to display programming guides, index information, weather information, news information, closed captioning text, or other textual information. Most television channel signals carry associated teletext data. When many typical televisions tune to a particular channel, the televisions store the channel's teletext data to a cache memory. When the user of the television changes the television tuner from one channel to another, the television discards all of the cached teletext data in preparation for receiving and caching teletext data from the newly acquired channel.

However, in a typical cable television system, the television may be unaware of a channel change and fail to clear its cache of teletext data. In such a system, subscribers are provided with a set-top box or terminal. The set-top terminal is a box of electronic equipment that is used to connect the subscriber's television, and potentially other electronic equipment, with a cable network. The set-top box is usually connected to the cable network through a co-axial wall outlet. When used with a set-top terminal, a television is typically set to a default channel such as channel 3 or channel 4, and any channel change is performed by the set-top terminal rather than by the television. The television channel remains unchanged at the default channel. Thus, the television is unaware of the channel change and the teletext cache is not cleared.

As a result of failing to clear the cache of teletext data upon a channel change, a typical television in a cable television network may mix the teletext data of any previous channel with the teletext data of the current channel. The television may even display teletext data associated with an old channel among the current channel's displayed teletext data. In a cable network system, it would be desirable to stop the mixing of previous channels' outdated teletext data the current channel's teletext data.

### SUMMARY

A method for clearing teletext data includes transmitting the teletext to a display device, tracking the transmitted teletext data, generating a representation of the transmitted teletext data, accessing the representation upon a channel change, and instructing the display device to clear the transmitted teletext data according to the accessed representation of the transmitted teletext data.

### BRIEF DESCRIPTION OF THE DRAWINGS

The accompanying drawings illustrate various embodiments of the present method and system and are a part of the specification. Together with the following description, the drawings demonstrate and explain the principles of the present method and system. The illustrated embodiments are merely examples of the present invention and do not limit the scope of the invention.

FIG. 1 illustrates an exemplary embodiment of a setup configured to clear teletext data from a display device.

FIG. 2 is a module-level diagram illustrating an exemplary embodiment of the flow of teletext data.

FIG. 3 is a flow diagram illustrating an exemplary method for processing teletext data.

FIG. 4 is a flow diagram illustrating an exemplary process for instructing a display device to clear teletext data from its cache.

FIG. 5 is a flow diagram illustrating an exemplary process for clearing teletext data page-by-page from a display device.

### DETAILED DESCRIPTION

The present method and system relate to clearing teletext data. More particularly, the present method and system relate to clearing cached teletext data by transmitting erase commands to a display device.

In the present specification and in the appended claims, a data packet is meant to be understood broadly as any discrete segment of data. Data signals are typically “packetized,” meaning that the data of a message or of software or firmware is divided into discrete “packets” or segments of data. Each packet includes at least a header that identifies the message or object of which that packet is a part and identifies the position of that packet's data within that message or object. Consequently, a receiver of the message can collect the packets of the message or object and reassemble the packetized data into the message or object that was transmitted. There are numerous types of data packets that are defined by established standards, including but not limited to moving pictures experts group (MPEG), packetized elementary stream (PES), teletext, transport, etc. Further, there are numerous types of data packets used that are not governed by published standards. Data packets can be nested within other data packets.

Standards exist that govern transmission signals to a television. A vertical blanking interval (VBI) signal is a part of most standardized transmission signals to televisions, including but not limited to European standard ETSI EN 301 775. A VBI signal is meant to be understood broadly as a part of a television transmission signal that is blanked to allow time for the television's electron gun to move from the bottom to the top of the screen as it scans images. The VBI signal can be used to broadcast data to a television or other compliant receiver device. The VBI signal can include different types of data, including but not limited to teletext data. A television is capable of decoding and using the data carried by VBI signals, including decoding and displaying any viewable image data associated with television programming.

“Teletext data” is meant to be understood broadly as a mechanism for transmitting data to a television or other display device. Teletext data can include but is in no way limited to viewable images or data, viewable pages, textual data, textual images, pages of textual data, programming information, programming guides, non-viewable data, index information, browser information, weather information, news information, and any other data usable by a display device. Teletext data can be data that is established by established standards, including but not limited to European Telecommunication Standard (ETS) 300 706. Teletext data can be associated with particular services or channels, such as a television programming channel. Teletext data can be organized into a page, a magazine, a service, or any other combination of teletext data. Multiple pages of teletext data can be organized into magazines.

In the following description, for purposes of explanation, numerous specific details are set forth in order to provide a thorough understanding of the present method and system for configuring parameters of a control device. It will be apparent, however, to one skilled in the art that the present method may be practiced without these specific details. Reference in the specification to “one embodiment,” “an example of one possible implementation of the present system and method,” “an embodiment,” or “an exemplary embodiment” means that a particular feature, structure, or characteristic described in connection with the embodiment is included in at least one embodiment. The phrases “in one embodiment” and “in an exemplary embodiment” appear in various places in the specification and are not necessarily all referring to the same embodiment.

Exemplary Overall Structure

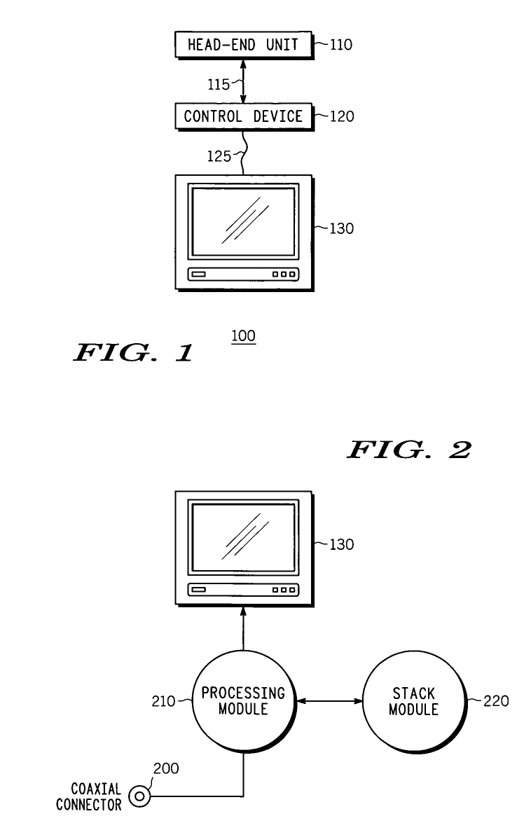

Referring now to the drawings, FIG. 1 shows an exemplary setup (100) that includes a head-end unit (110) communicatively coupled to a control device (120) by a transmission medium (115). Signals, including programming signals, VBI signals, and teletext data, can be transmitted from the head-end unit (110) to the control device (120) via the transmission medium (115). The control device (120) is communicatively coupled to a display device (130) by a transmission medium (125). Signals, including programming signals, VBI signals, and teletext data, can be transmitted from the control device (120) to the display device (130) via the transmission medium (125). The elements of the exemplary setup (100) shown in FIG. 1 will now be discussed in further detail below.

As shown in FIG. 1, signals are transmitted from the head-end unit (110) to the control device (120). The head-end unit (110) can be any signal broadcaster capable of communicating with the control device (120) via the transmission medium (115), including but not limited to, a facility or component at a signal production office that communicates television, modem, or other services (collectively “services”) to subscribers. The services may include, but are in no way limited to, satellite, cable, analog, digital, or other type of television or network service.

The head-end unit (110) typically includes a satellite dish antenna for receiving incoming programming and message signals from a broadcasting station that broadcasts services. The service signals may be transmitted to the head-end unit (110) in a number of ways including, but not limited to, a satellite dish, a fiber-optic cable, a coaxial cable, a phone line, a wireless medium, and the like. The head-end device (110) then transmits signals to the control device (120) via the transmission medium (115). The transmission medium (115) is any medium capable of carrying communications from the head-end unit (110) to the control device (120), including but not limited to a coaxial cable, a fiber-optic cable, a phone line, a medium for propagating wireless communications, etc.

The signals transmitted from the head-end unit (110) to the control device (120) can be any data format, including but not limited to digital video broadcast (DVB) signals, MPEG-type formatted data, PES formatted data, MPEG PES formatted data, teletext data, programming signals, VBI signals, and any other signal related to television or network services. In an exemplary embodiment, the signals transmitted from the head-end unit (110) to the control device (120) include VBI signals and teletext data.

The control device (120) receives and processes the service signals, including teletext data. The control unit (120) can be any circuitry or programmable device configured to receive broadcast signals and process data associated with the received signals. The control device (120) is meant to be understood broadly as any electrical component such as a set-top box or a receiver unit that is configured to receive a signal from a head-end unit and process data associated with the received signal. The control unit (120) can comprise processors, memory, peripherals, computer-readable mediums, input devices, output devices, transmitters, receivers, processor readable carriers, or any other computer-related component. The control device (120) may be associated with television or network services, including cable or satellite television services. In one exemplary embodiment, the control device (120) is a set-top box (STB) associated with cable television services. A set-top box is meant to be understood broadly as any device that enables a display device such as a television to receive and display programming or network services.

The control unit (120) may be configured or programmed to control services that are transmitted or made available to the display device (130). The control device (120) can process and otherwise manipulate, arrange, or assemble the received signals in preparation for transmitting a signal to the display device (130). The control unit (120) may include modules that perform the processing of the service signals in preparation for transmission to the display device (130). Once the control unit (120) has prepared a transmission signal, it transmits the signal to the display device (130) via the transmission medium (125). The signals transmitted from the control device (120) to the display device (130) can be any data format, including but not limited to digital video broadcast (DVB) signals, MPEG-type formatted data, PES formatted data, MPEG PES formatted data, teletext data, programming signals, VBI signals, and any other signal related to television or network services. In an exemplary embodiment, the control device (120) transmits a signal that includes a VBI signal to the display device (130). The control unit (120) can insert teletext data into the VBI signal for transmission.

The control device (120) can track data, such as teletext data, as it is received or as it is transmitted to the display device (130). The control device (120) can track data in a wide variety of ways, including but not limited to storing data in a database, a dynamic stack, or any other memory structure. The stored data can be accessed by the control device (120). In an exemplary embodiment, transmitted teletext data or a copy of transmitted teletext data is written and indexed to a database.

As shown in FIG. 1, the control device (120) is communicatively coupled to the display device (130), such as a television, by the transmission medium (125). The transmission medium (125) is any medium capable of carrying communications from the control device (120) to the display device (130), including but not limited to conductive wire, a coaxial cable, a fiber-optic cable, a phone line, a medium for propagating wireless communications, and the like. The control unit (120) enables the display device (130) to receive and display television, network, or other services, including teletext data. The display device (130) can be any device capable of displaying or recording television or network services, including but in no way limited to a television, a computer monitor, a flat-panel screen, a digital video recorder (DVR), a video cassette recorder (VCR), a digital video disc (DVD) player, a projector, and the like. In an exemplary embodiment, the display device (130) is a television.

Although FIG. 1 shows one head-end unit (110), one control device (120), and one display device (130) for illustrative purposes, it will be clear to one of ordinary skill in the art that the present system and method contemplates that the setup (100) can include more than one of each item, including a wide variety of different combinations of devices. In an exemplary embodiment, the head-end unit (110) interfaces with multiple control devices (120).

FIG. 2 shows an exemplary embodiment of the flow of teletext data as it is processed, tracked, and transmitted by the control device (120; FIG. 1). Service signals are received via the transmission medium (115; FIG. 1), which transmission medium (115; FIG. 1) is represented by a coaxial connector (200) in FIG. 2. The service signals can include data in any of the formats discussed above in relation to FIG. 1. In an example of one possible implementation of the present system and method, the service signals include MPEG PES formatted data.

A processing module (210) receives data and signals that are associated with the received service signals. The processing module (210) processes the received data in preparation for transmission to the display device (130). The processing module (210) can be configured to create, configure, and assemble data of different types and from different sources into signals that can be transmitted to and processed by the display device (130). The processing of the received data may include extracting teletext data from a signal or data packet and decoding the teletext data for farther processing. The processing module (210) can process the teletext data and encode and insert it into a data packet or signal in preparation for transmission to the display device (130). The encoding and inserting of teletext data can be performed in a number of ways, including but not limited to hardware assisted insertion and software controlled insertion. Some methods of encoding and inserting teletext data are known in the art.

Once processing of the service signals and any other associated data is complete, the processing module (210) transmits a signal to the display device (130). As discussed above in relation to FIG. 1, signals transmitted to the display device (130) can include teletext data. In an exemplary embodiment, the transmitted signal includes a VBI signal, which VBI signal includes inserted teletext data. The teletext data can be nested within various forms of data packets. In one exemplary embodiment, the teletext data is carried by transport packets or PES packets.

As shown in FIG. 2, the processing module (210) interfaces with a stack module (220) and the display device (130). The processing module (210) can communicate with the display device (130) in any way discussed above in relation to FIG. 1. The processing module (210) and the stack module (220) can interface by a variety of communication formats, including any format capable of transmitting data or instructions, including but not limited to transmissions of data packets.

The processing module (210) can track data that is transmitted to the display device (130). When the processing module (210) transmits data, such as teletext data, to the display device (130), the processing module (210) can be configured to communicate the transmitted data or a copy of the transmitted data to the stack module (220). The stack module (220) is configured to store the data to a processor-readable medium. Through this process, the stack module maintains a history of data such as teletext data that has been transmitted to the display device (130). The stack module can store data in a wide variety of ways, including but not limited to writing the data to a database, a dynamic stack, or any other memory structure from which data can be accessed. In an exemplary embodiment, the stack module (220) is configured to write and index transmitted teletext data or a copy of transmitted teletext data to a database.

The processing module (210) can access the data stored by the stack module (220). The processing module (210) can instruct the stack module (220) to access stored data. The stack module (220) may be configured to access any data that it has stored and to transmit stored data or data related to stored data to the processor module (210). An index can be used to iteratively access the stored data. The stored data can be used to track and determine what data has been transmitted to, and presumably received and cached by, the display device (130). In an exemplary embodiment, the stack module (220) accesses stored data from an indexed database.

The processing module (210) can instruct the stack module (220) to access and transmit stored data. In an exemplary embodiment, the stack module (220) is instructed to access and transmit the stored data upon receiving an indication that a service channel has been changed to another service channel. Upon notification of a clear instruction, the stack module (220) can access data that it has caused to be stored in a computer-readable medium. The stack module (220) can assemble the stored data, including teletext data, into a wide variety of data formats for transmission to the processing module (210) or to the display device (130). In an exemplary embodiment, the stack module (220) assembles stored teletext data, or data related to stored teletext data such as a teletext data identifier, into data packets, including but not limited to transport packets, PES packets, teletext packets, and the like. The assembled data packets that can include data capable of identifying pages and magazines of teletext data. The packets of data can include a page identifier, a magazine identifier, and a number of zero value data packets.

The stack module (220) transmits the assembled data packets to the processing module (210) for insertion into a signal that is configured to be transmitted to the display device (130). The data associated with stored teletext data can be communicated to the processing module (210) in any communicative way, many of which are known in the art. In an exemplary embodiment, the stack module (220) creates a transport buffer and transport packets for transmission to the transport buffer. The processing module (210) can then access the transport packets when the processing module (210) becomes ready. In an exemplary embodiment, the stack module (220) controls the transmission of data packets to the display device (130).

The processing module (210) can insert the received data, including data packets, into a signal and transmit the signal to the display device (130). The processing module (210) can insert the data into a VBI signal and transmit the signal to the display device (130). Upon receiving, decoding, and processing of the VBI signal, the display device (130) will clear the identified pages or magazines of cached teletext data by writing the zero value data packets to the identified pages or magazines of cached teletext data.

Once data has been transmitted to clear the cache of the display device (130), the stack module (220) can clear the stored data from memory and reset index values in preparation for storing new teletext data associated with a new channel. The stack module (220) can clear out the memory in a variety of ways known in the art. In an exemplary embodiment, the stack module (220) clears the stored data from memory after all of the data has been accessed and transmitted to the processing module (210). In another embodiment, the stored data is cleared after signals including the clear instructions and associated data have been transmitted to the display device (130). In another embodiment, each unit of stored data, such as a page of teletext data, is cleared as it is accessed in relation to a clear instruction.

Exemplary Implementation and Operation

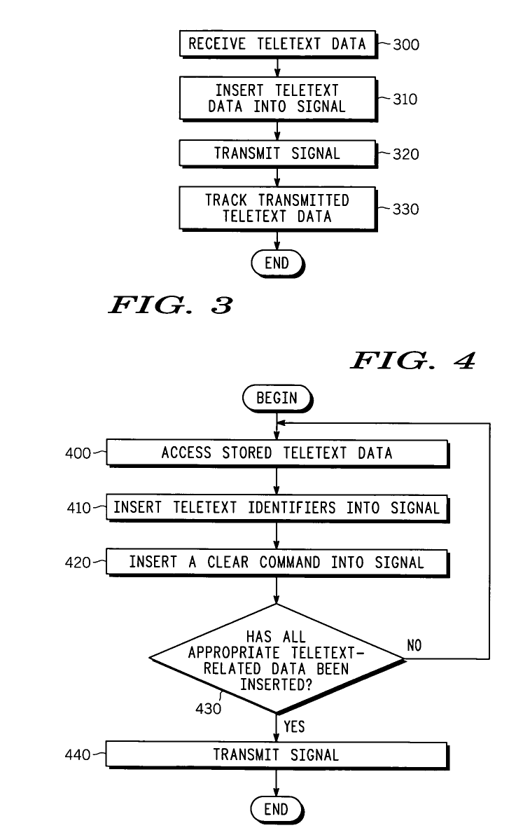

FIG. 3 shows an exemplary method for processing and tracking teletext data. As shown in FIG. 3, the present method begins by receiving teletext data (step 300). The teletext data can be included in any format discussed above. In an exemplary embodiment, the received teletext data (step 300) is included in an MPEG PES data format.

FIG. 3 next shows that the received teletext data is inserted into a signal (step 310). The received teletext data can be decoded, processed, and encoded in preparation for insertion into the signal. The signal can be of any format and include any data format that can be communicated to the display device (130; FIG. 1), as discussed above in relation to FIG. 1.

Once teletext data has been inserted into the signal, the signal is transmitted (step 320) to the display device (130; FIG. 1). The display device (130; FIG. 1) can decode and process the teletext data that is carried by the signal. In an exemplary embodiment, the teletext data is inserted into a VBI signal, and the VBI signal is transmitted to the display device (130; FIG. 1).

As shown in FIG. 3, the transmitted teletext data is tracked (step 330). The transmitted teletext data can be tracked (step 330) in a number of ways, including but not limited to storing the transmitted teletext data or a copy of the transmitted teletext data to a processor-readable medium in any of the ways discussed above. The transmitted teletext data may be tracked by storing a part of data that is associated with the transmitted teletext data. For example, identification data associated with the transmitted teletext data can be tracked. In an exemplary embodiment, transmitted teletext data is tracked by storing associated data that can identify a page, magazine, or other grouping of transmitted teletext data. The steps shown in FIG. 3 repeat as teletext data is received as long as transmission of teletext data to the display device (130; FIG. 1) has not been disabled.

FIG. 4 shows an exemplary method for clearing cached teletext data. The present method is initiated when the control device (120; FIG. 1) tunes away from a channel that includes teletext programming. As shown in FIG. 4, the present method begins by accessing stored teletext data (step 400). The accessing of the stored teletext data (step 400) can be performed in a wide variety of ways such as those discussed above in relation to FIG. 2, including by accessing each page of teletext data in reverse order from the sequence in which it was stored. In an exemplary embodiment, the stored teletext data is accessed (step 400) by incrementally accessing indexed pages of the stored teletext data.

As shown in FIG. 4, the next step in the present method includes inserting teletext identifiers into a signal (step 410). The inserted teletext identifiers can include any information that is associated with the stored teletext data and can be used to identify the teletext data in the cache of the display device (130; FIG. 1), including but not limited to a page address, a page identifier, and a magazine identifier.

A clear command is then inserted into the signal (step 420). The clear command is any command or data capable of instructing the display device (130; FIG. 1) of clearing cached teletext data or any particular teletext data object within the cache of teletext data. Zero value data packets can be associated with the teletext identifiers and the clear command. The zero value packets may be used by the display device (130; FIG. 1) to clear the cached teletext data that is identified by the teletext identifiers associated with the zero value data packets. The zero value data packets can be inserted into the transmission signal along with the teletext identifiers. In an exemplary embodiment, upon reception of a clear command, the display device (130; FIG. 1) clears its cached teletext data by writing the zero value packets over the teletext data identified by the teletext identifiers. The written zero value data packets erase the stored teletext data.

The next step includes determining whether all appropriate teletext-related data has been inserted (step 440). If all of the appropriate teletext-related data has not been inserted (step 440), steps 400-430 will be repeated to access the next stored teletext data object, such as a page of teletext data. If all of the appropriate teletext-related data has been inserted (step 430) into the signal, then the signal is transmitted (step 440) to the display device (130; FIG. 1), and the clear process terminates. This determination can be made by monitoring the insertion of data into the signal, by determining when all of the stored data has been accessed, or by using ways that will be known to one of skill in the art. The display device (130; FIG. 1) can decode and process the signal to clear its cached teletext data.

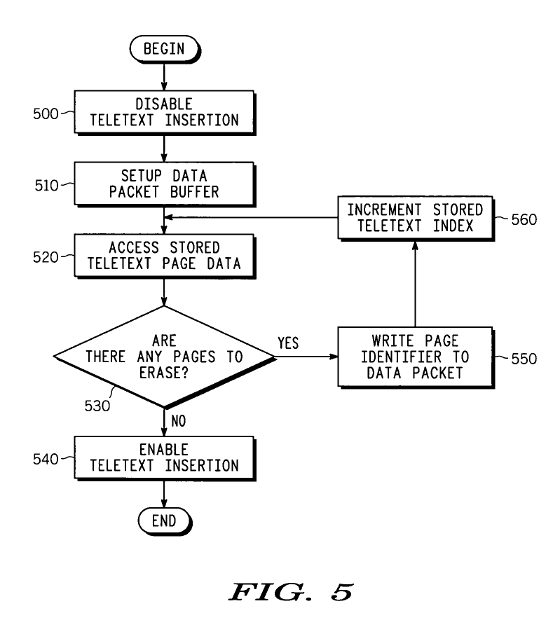

FIG. 5 shows a flow diagram of an exemplary process for clearing cached teletext data. The present method of clearing teletext can begin upon the changing of a channel, such as a television services channel. In an exemplary embodiment, the clearing of cached teletext is initiated when the control unit (120; FIG. 1) tunes away from a channel that includes teletext programming. In another exemplary embodiment, the clearing of cached teletext is initiated when the control device (120; FIG. 1) tunes away from a channel that includes viewable teletext data.

When the process of clearing cached teletext data has been initiated, the insertion of teletext is disabled (step 500). In other words, the control unit (120; FIG. 1) stops inserting teletext data into the signal, such as a VBI signal, for transmission to the display device (130; FIG. 1). The cessation of teletext insertions allows cached teletext data to be cleared before any new teletext data can be cached by the display device (130; FIG. 1).

As shown in FIG. 5, the next step in the present method includes the setup of a data packet buffer (step 510). The data packet buffer can be setup (510) to receive and hold data packets. The buffer allows completed data packets to be made available as the data packets are completed rather than having to synchronize the availability of the data packets with transmissions to the display device (130; FIG. 1). The data packets can be accessed in the buffer for transmission to the display device (130; FIG. 1). The buffer allows different types of data packets to be generated and transmitted at different times without the need for synchronization of generation and transmission events. In an exemplary embodiment, the data packets are transport packets generated as PES data packets.

Once the data packet buffer is setup (step 510), a stored teletext page is accessed (step 520). As discussed above in relation to FIG. 3, teletext data that is transmitted to the display device (130; FIG. 1) can also be stored for later access. Step 520 involves the accessing of previously stored teletext data, which teletext data can be stored by various groupings of data, such as pages and magazines of teletext data.

The next step includes determining whether there are any pages to erase (step 530). If there are no stored pages to be accessed or if all stored pages have already been accessed during the present method illustrated in FIG. 5, then the insertion of teletext is enabled (step 530) to allow the insertion of teletext data into the transmission signal to be continued. Once the insertion of teletext is enabled (step 540), the transmission of teletext data to the display device (130; FIG. 1) is resumed, and the exemplary process of clearing cached teletext data is terminated.

On the other hand, if a stored teletext page exists and is accessed, then there exists a page to be erased (step 530). Page identifiers are then inserted into a data packet (step 550). The accessed teletext page (step 520) represents a page to be erased from the cache of the display device (130; FIG. 1). Page identifiers can be any information that can identify the page in the cache of the display device (130; FIG. 1) that is associated with the accessed page, including but not limited to a page number, a page address, and a magazine number. As discussed above, a clear command and zero value data packets can be associated with the page identifiers and inserted into data packets for transmission to the display device (130; FIG. 1).

Next, the stored teletext index is incremented (step 560) and steps 520, 530, 550, and 560 are repeated until there are no more stored teletext pages remaining to be accessed. Once a data packet is filled to capacity or there are no more stored teletext pages to access, the data packet is transmitted to the data packet buffer in preparation for transmission to the display device (130; FIG. 1). In an exemplary embodiment, the data packets, such as PES packets, are inserted into a VBI signal for transmission to the display device (130; FIG. 1). The display device (130; FIG. 1) can process the data packets and clear, or flush, corresponding cached teletext data pages.

In conclusion, the present method and system for clearing cached teletext data, in its various embodiments, allows for clearing the teletext cache of a display device when a control unit switches from one channel that includes teletext data to another channel, even if the display device is unaware of the channel change. Specifically, the present method and system provide for instructing the display device to clear cached teletext data, thereby preventing one channel's teletext data from being mixed with another channel's teletext data.

The preceding description has been presented only to illustrate and describe the present method and system. It is not intended to be exhaustive or to limit the present method and system to any precise form disclosed. Many modifications and variations are possible in light of the above teachings.

The foregoing embodiments were chosen and described in order to illustrate principles of the method and system as well as some practical applications. The preceding description enables others skilled in the art to utilize the method and system in various embodiments and with various modifications as are suited to the particular use contemplated. It is intended that the scope of the method and system be defined by the following claims.

1. A method for clearing teletext data comprising:
transmitting said teletext data to a display device;
tracking said transmitted teletext data;
generating a representation of said transmitted teletext data;
accessing said representation upon a channel change; and
instructing said display device to clear said transmitted teletext data according to said accessed representation of said transmitted teletext data.

2. The method of claim 1, wherein said display device is one of a television and a recording device.

3. The method of claim 1, wherein said display device is unaware of said channel change.

4. The method of claim 1, wherein said channel change does not change a selected channel of said display device.

5. The method of claim 1, wherein said channel change comprises tuning away from a channel that includes said teletext data.

6. The method of claim 1, further comprising:
disabling a transmission of data associated with a new channel upon said channel change; and
enabling said transmission of said data associated with said new channel upon said instructing said display device to clear said transmitted teletext data according to said accessed representation of said transmitted teletext data.

7. The method of claim 1, wherein said transmitted teletext data includes a page of said teletext data.

8. The method of claim 7, wherein said representation includes a page identifier configured to identify said page of said teletext data and a number of zero value data objects configured to clear said page of said teletext data.

9. A system for clearing teletext data comprising:
a control device; and
a display device communicatively coupled to said control device;
wherein said control device is configured to transmit said teletext data to said display device, generate a representation of said teletext data, access said representation upon a channel change, and instruct said display device to clear said transmitted teletext data according to said accessed representation of said teletext data.

10. The system of claim 9, wherein said control device is a set-top box.

11. The system of claim 9, wherein said display device is one of a television and a recording device.

12. The system of claim 9, wherein said display device is unaware of said channel change.

13. The system of claim 9, wherein said channel change does not change a selected channel of said display device.

14. The system of claim 9, wherein said channel change comprises tuning away from a channel that includes said teletext data.

15. The system of claim 9, wherein said transmitted teletext data includes a page of said teletext data.

16. The system of claim 15, wherein said representation includes a page identifier configured to identify said page of said teletext data and a number of zero value data objects configured to clear said page of said teletext data.

17. The system of claim 9, further comprising a data packet configured to be transmitted to said display device for clearing a page of said transmitted teletext data, wherein said data packet includes a page identifier associated with said page of said transmitted teletext data, a clear command, and a number of zero value data objects configured to clear said page of said transmitted teletext data.

18. A system for clearing teletext data comprising:
a control means for receiving, processing, and transmitting a signal, said signal including said teletext data; and
a display means communicatively coupled to said control means;
wherein said control means is configured to transmit said teletext data to said display means, generate a representation of said teletext data, access said representation upon a channel change, and instruct said display device to clear said transmitted teletext data according to said accessed representation of said teletext data.

19. The system of claim 18, wherein said control means comprises a set-top box associated with one of cable television services and satellite television services.

20. The system of claim 18, wherein said display means comprises one of a television, a recording device, and a projector.

21. The system of claim 18, wherein said display means is unaware of said channel change.

22. The system of claim 18, wherein said channel change does not change a selected channel of said display means.

23. The system of claim 18, wherein said signal comprises a vertical blanking interval (VBI) signal.

24. A control device for clearing teletext data comprising:
a processing module configured to receive said teletext data, process said teletext data, and transmit a signal to a display device, said signal including said teletext data; and
a stack module communicatively coupled to said processing module;
wherein said stack module is configured to generate a representation of said transmitted teletext data, access said representation upon a channel change, and insert a data packet into said signal for transmission to said display device, said data packet comprising a clear command, a packet identifier configured to identify said transmitted teletext data that is associated with said accessed representation of said teletext data, and a number of zero value data objects configured to erase said identified teletext data.

25. The control device of claim 24, wherein said channel change comprises tuning away from a channel that includes said teletext data.

26. The control device of claim 24, wherein said channel change does not change a selected channel of said display device.

27. A data packet comprising:
a clear command for instructing a display device to clear teletext data associated with a cache of said display device;
a page identifier configured to identify a page of said teletext data; and
a number of zero value data objects configured to be written to said identified page of said teletext data.

28. A processor-readable carrier including processor instructions that instruct a processor to perform the steps of:
transmitting said teletext data to a display device;
tracking said transmitted teletext data;
generating a representation of said transmitted teletext data;
accessing said representation upon a channel change; and
instructing said display device to clear said transmitted teletext data according to said accessed representation of said transmitted teletext data.

29. The processor-readable carrier of claim 28, wherein said processor instructions further instruct a processor to disable a transmission of data associated with a new channel upon said channel change and enable said transmission of said data associated with said new channel upon said instructing said display device to clear said transmitted teletext data according to said accessed representation of said transmitted teletext data.

30. The processor-readable carrier of claim 28, wherein said instructing said display device to clear said transmitted teletext data includes clearing a page of said transmitted teletext data.
